(19) United States
(12) Patent Application Publication
(10) Pub. No.: US 2013/0304970 A1
(43) Pub. Date: Nov. 14, 2013

(54) SYSTEMS AND METHODS FOR PROVIDING HIGH PERFORMANCE REDUNDANT ARRAY OF INDEPENDENT DISKS IN A SOLID-STATE DEVICE

(71) Applicant: STEC, Inc., Santa Ana, CA (US)

(72) Inventor: Hadi Torabi PARIZI, Irvine, CA (US)

(21) Appl. No.: 13/866,337

(22) Filed: Apr. 19, 2013

Related U.S. Application Data
(60) Provisional application No. 61/636,128, filed on Apr. 20, 2012.

(51) Int. Cl. G06F 3/06

(52) U.S. Cl. CPC G06F 3/0619; G06F 3/0688; G06F 3/0656
USPC 711/103

(57) ABSTRACT

The present disclosure relates to systems and methods for providing high performance Redundant Array of Independent Disks (RAID) in a solid-state device. The present disclosure includes a solid state device. The solid state device can include a buffer having a plurality of bit cells, configured to maintain a plurality of bits of information. The solid state device can also include a memory controller configured to logically partition the plurality of bit cells into a plurality of logical blocks, each configured to maintain a data block. The solid state device can additionally include a RAID engine coupled to the buffer, where the buffer is configured to provide data blocks to the RAID engine, and in response, the RAID engine is configured to compute first parity bits from the data blocks and directly provide the first parity bits to one of a plurality of flash memory devices.

### CROSS-REFERENCE TO RELATED APPLICATION

This application claims the benefit of the earlier priority date of U.S. Provisional Patent Application No. 61/636,128, entitled “DYNAMIC ERROR HANDLING,” filed on Apr. 20, 2012, which is hereby expressly incorporated herein by reference in its entirety.

### TECHNICAL FIELD

The disclosed subject matter relates generally to systems and methods for providing high performance Redundant Array of Independent Disks (RAID) in a solid-state device.

### BACKGROUND

In computing systems, data are stored on physical data storage devices, such as solid-state storage devices (SSD), flash storage devices, and hard drives. Data storage devices have become increasingly mainstream as their manufacturing costs continue to decline and as they are more accessible to the public. Furthermore, the increased complexity of computer applications and the increased size of various types of documents create further demands for high-capacity data storage devices. As capacities of data storage devices increase, consumers also expect the performance of the data storage devices to increase correspondingly.

One data storage scheme for providing high-capacity high-performance data storage devices is called Redundant Array of Independent Disks, or Redundant Array of Inexpensive Disks (“RAID”). A RAID system often includes an array of memory devices logically combined as a single storage unit. The RAID system can be configured as one of several standard levels, depending on how the RAID system maintains data in the array of memory devices. For example, the RAID system can be configured as RAID 0, RAID1, RAID 2, RAID 3, RAID 4, RAID 5, RAID 6, or RAID 10.

### SUMMARY

Some embodiments of the disclosed subject matter include a solid state device. The solid state device can include a buffer having a plurality of bit cells, configured to maintain a plurality of bits of information. The solid state device can also include a memory controller configured to logically partition the plurality of bit cells into a plurality of logical blocks, each configured to maintain a data block comprising at least one bit of information. The solid state device can additionally include a Redundant Array of Independent Disks (RAID) engine coupled to the buffer, where the buffer is configured to provide a plurality of data blocks from the plurality of logical blocks to the RAID engine, and in response, the RAID engine is configured to compute first parity bits from the plurality of data blocks and directly provide the first parity bits to one of a plurality of flash memory devices.

In some embodiments, the buffer is further configured to provide the plurality of data blocks, stored in the plurality of logical blocks, to the plurality of flash memory devices.

In any of the disclosed embodiments, the buffer is configured to provide the plurality of data blocks to the plurality of flash memory devices based on a RAID 5 scheme.

In any of the disclosed embodiments, the buffer is configured provide the plurality of data blocks to the RAID engine and to the plurality of flash memory devices substantially simultaneously.

In any of the disclosed embodiments, the RAID engine is configured to perform a bit-wise exclusive OR (XOR) operation on at least two of the plurality of data blocks.

In any of the disclosed embodiments, the solid state device can also include an error correcting code (ECC) engine, configured to receive the plurality of data blocks and the first parity bits from the plurality of flash memory devices and determine whether one of the plurality of data blocks comprises a bit-error.

In any of the disclosed embodiments, the ECC engine is configured to compute temporary parity bits based on the plurality of data blocks and compare the temporary parity bits to the first parity bits received from the plurality of flash memory devices to determine whether one of the plurality of data blocks comprises a bit-error.

In any of the disclosed embodiments, when one of the plurality of data blocks comprises a bit-error, the RAID engine is configured to compute second parity bits based on portions of the plurality of data blocks without the bit-error and the first parity bits, and provide the second parity bits to the buffer.

In any of the disclosed embodiments, the ECC engine is a part of the RAID engine.

In any of the disclosed embodiments, the plurality of flash memory devices is configured to provide the plurality of data blocks to the buffer and the ECC engine substantially simultaneously.

Some embodiments of the disclosed subject matter include a method of operating a solid-state device. The method can include partitioning, by a memory controller, a plurality of bit cells in a buffer into a plurality of logical blocks, each of which is configured to maintain a data block comprising at least one bit of information, receiving data, by the buffer, from a host device, and maintaining the data in the plurality of logical blocks as a plurality of data blocks, and providing, by the buffer, the plurality of data blocks to a RAID engine. The method can further include computing, by the RAID engine, first parity bits from the plurality of data blocks, and providing, by the RAID engine, the first parity bits directly to one of a plurality of flash memory devices.

In some embodiments, the method can further include providing, by the buffer, the plurality of data blocks, stored in the plurality of logical blocks, to the plurality of flash memory devices.

In any of the disclosed embodiments, providing the plurality of data blocks to the plurality of flash memory devices comprises providing provide the plurality of data blocks to the plurality of flash memory devices based on a RAID 5 scheme.

In any of the disclosed embodiments, providing the plurality of data blocks to the RAID engine and providing the plurality of data blocks to the plurality of flash memory devices occur substantially simultaneously.

In any of the disclosed embodiments, computing the first parity bits from the plurality of data blocks comprises performing a bit-wise exclusive OR (XOR) operation on at least two of the plurality of data blocks.

In any of the disclosed embodiments, the method can further include receiving, by an error correcting code (ECC) engine, the plurality of data blocks and the first parity bits from the plurality of flash memory devices; and determining, by the ECC engine, whether one of the plurality of data blocks comprises a bit-error.

In any of the disclosed embodiments, the method can further include computing, by the ECC engine, temporary parity bits based on the plurality of data blocks; and comparing, by the ECC engine, the temporary parity bits to the first parity bits received from the plurality of flash memory devices, thereby determining whether one of the plurality of data blocks comprises a bit-error.

In any of the disclosed embodiments, when one of the plurality of data blocks comprises a bit-error, the method can further include computing, by the RAID engine, second parity bits based on portions of the plurality of data blocks without the bit-error and the first parity bits; and providing, by the RAID engine, the second parity bits to the buffer.

In any of the disclosed embodiments, the RAID engine includes the ECC engine.

In any of the disclosed embodiments, the method can further include providing, by the plurality of flash memory devices, the plurality of data blocks to the buffer and the ECC engine substantially simultaneously.

### DESCRIPTION OF FIGURES

The following description will be more readily understood with references to the following drawings in which:

FIG. 1 illustrates a typical process of the RAID 5 scheme.

FIG. 2 illustrates a process for writing data to a data storage device in accordance some embodiments of the disclosed subject matter.

FIG. 3 illustrates a detailed process for writing data to a data storage device in accordance some embodiments of the disclosed subject matter.

FIG. 4 illustrates a high level flow chart illustrating the process for writing host data in accordance with some embodiments of the disclosed subject matter.

FIG. 5 illustrates a process for reading data from a data storage device in accordance with some embodiments of the disclosed subject matter.

FIG. 6 illustrates a detailed process for reading data from a data storage device in accordance with some embodiments of the disclosed subject matter.

FIG. 7 illustrates a flow chart illustrating a read process in accordance with some embodiments of the disclosed subject matter.

### DESCRIPTION

The storage capacity of SSDs can be increased by using flash memory devices having high-capacity multi-level cells (“MLCs”), which can hold at least twice as many bits of data as the alternative bit cell: a single-level cell (“SLC”). The use of flash memory devices having MLCs unfortunately comes at a price of reduced lifetime of SSDs. The lifetime (i.e., longevity) of bit cells is dependent on the number of program/erase (“PIE”) cycles performed on the cells. A typical erasure limit for SLCs is about 100,000 cycles and a typical erasure limit for MLCs is about 5,000-10,000 cycles. As the number of P/E cycles of a cell reaches closer to this erasure limit, the bit error rate (“BER”) of the cell also increases. Cells with a higher BER are less reliable than those with a lower BER, and are more likely to produce errors and lead to a data storage device failure.

One way to maintain the integrity of a data storage device even with a high BER of memory devices is to install a RAID system. A RAID system provides a variety of benefits, two of which include (1) the increased performance and (2) the protection of the data integrity. The RAID system can increase the performance by utilizing multiple storage devices that can read and write in parallel, allowing several devices to co-operate with one another. This is achieved through a method called block-level striping. In striping, sequential data are divided into segments and stored across several devices in a RAID array. Distributing the data in this manner prevents a bottleneck from occurring during a data transfer execution command, thereby increasing the speed of the data transfer.

The RAID system can maintain data integrity by providing data redundancy. The RAID system provides the data redundancy by generating parity bits and distributing the parity bits across the storage devices in the RAID array. The parity bits can be used to recreate any lost/contaminated data due to any number of reasons, such as error or device failure.

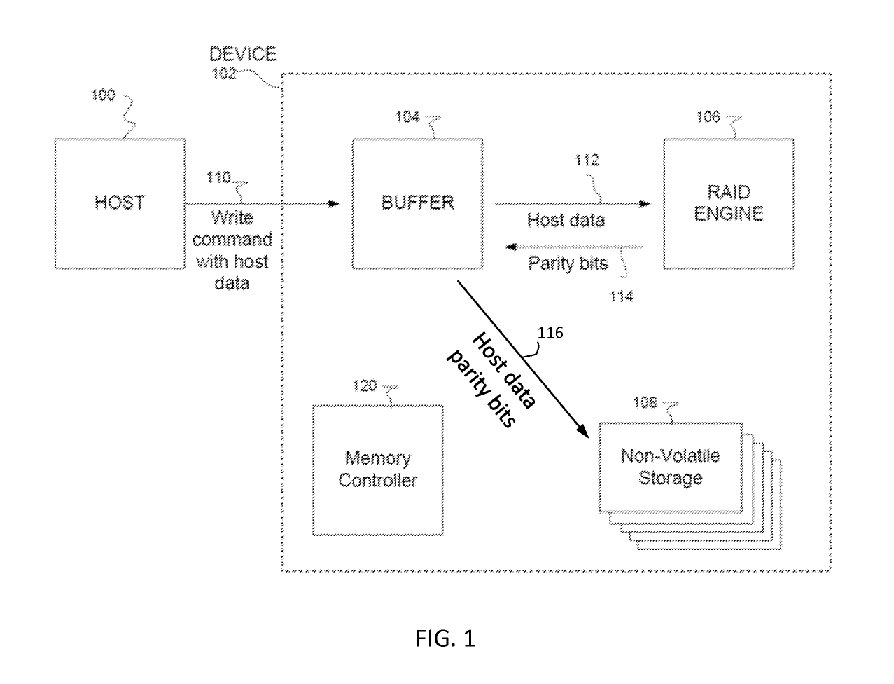

The RAID operations in a data storage device can be transparent to a host device that is storing data into the data storage device or reading data from the data storage device. FIG. 1 illustrates an operation of the RAID 5 configuration. FIG. 1 shows a host device 100 connected to a data storage device 102. The data storage device 102 has a buffer 104, a RAID engine 106, one or more non-volatile storage devices 108, and a memory controller 120.

To initiate a write process, the host device 100 can issue a write command 110 to the data storage device 102 to cause the data storage device 102 to store host data. The memory controller 120 can temporarily store the host data at a buffer 104, where the host data is logically segmented into several logical blocks, the size of which may be based on the assignment from a controller 120. For example, the buffer 104 can be logically segmented into eight logical blocks, with seven of the logical blocks to be occupied by the host data. The buffer 104 leaves at least one logical block empty so that the buffer 104 can receive parity bits from the RAID engine 106, as described below.

While the host data resides in the buffer 104, the buffer 104 can send the host data 112 to the RAID engine 106. The RAID engine 106 can process the host data 112 to compute parity bits, and send back the parity bits 114 to the buffer 104. For example, the buffer 104 can receive the parity bits 114 at the eighth logical block of the buffer 104. Then, as shown by 116, each logical block of the buffer 104 is striped, for example, in a round-robin fashion and the data in each logical block are written to various locations of the one or more non-volatile storage devices 108. In some cases, the striping of the logical blocks in the buffer 104 can be performed by the memory controller 120.

The parity bits can be newly computed (or modified) whenever the underlying data are changed. To this end, the parity bits residing in one or more non-volatile storage devices are sent to a buffer, and are modified in the buffer to reflect the newly created data. The new parity bits are then re-written into the one or more non-volatile storage devices.

However, due to the nature of storage devices and the technology used in SSDs, recalculating parity bits on each write can be cumbersome and can be a bottleneck in performance. Because the above steps are performed by a firmware, the above steps can limit the performance of the memory system. Furthermore, with each additional RAID configuration, the firmware complexity increases and performance is negatively affected. As firmware complexity increases, it becomes more stressed and requires increased development and testing costs.

The present disclosure includes systems and methods for addressing challenges illustrated above. In particular, the present disclosure teaches systems and methods for improving the efficiency of RAID operations in a SSD system. The disclosed systems and methods can improve the performance of the SSD system in several ways. First, the disclosed systems and methods can perform the RAID operations in parallel (i.e., substantially simultaneously) with the reading and writing of data in non-volatile storage devices. For example, during a write operation, the buffer in the data storage device can provide the host data to both the RAID engine and the non-volatile storage devices in parallel. The parallel RAID operations has at least two benefits. As a first benefit, the data storage device can store the host data in the non-volatile storage devices without waiting for the RAID engine to complete the required RAID operations. Thus, the substantially simultaneous operation of the RAID engine and the non-volatile storage devices can substantially reduce the latency of the data storage device. As a second benefit, the parallel RAID operations effectively shorten the data path for parity bits computed by the RAID engine. Once the RAID engine computes the parity bits from the host data, the RAID engine can directly provide the parity bits to non-volatile storage devices instead of sending the parity bits back to the buffer. This way, the data storage device can reduce superfluous data transfers, which can reduce the power consumption and the latency of the data storage device.

The disclosed systems and methods can also provide a robust read operation that can correct certain types of bit-errors in flash memory devices. For example, if one of the data blocks retrieved from the non-volatile storage devices has a bit-error, then the disclosed systems and methods can correct the bit-error before providing the retrieved data to the host device. The disclosed systems and methods can correct the bit-error using the parity bits associated with the data blocks, which are computed during the write operation. Furthermore, the disclosed systems and methods can correct the bit-error without incurring substantial latency because the bit-error correction can be performed substantially simultaneously with the data retrieval process.

The disclosed systems and methods can implement the RAID process in hardware, which allow the disclosed systems and methods to perform the RAID process in real-time. The disclosed systems and methods can be particularly useful for the RAID 5 configuration, but can also be useful for other RAID configurations, including the RAID 6 configuration.

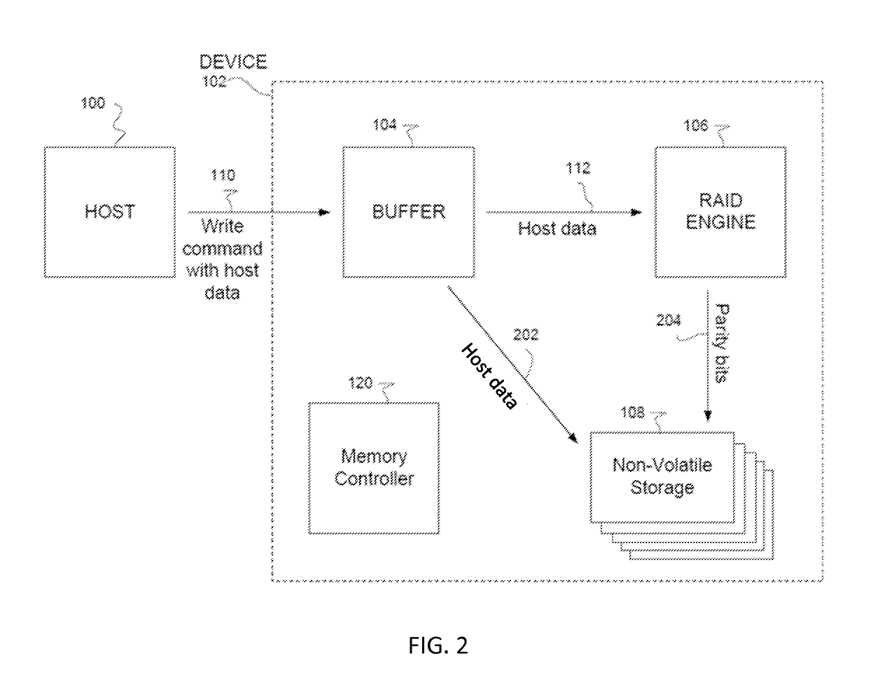

FIG. 2 illustrates a process for writing data to a data storage device in accordance some embodiments of the disclosed subject matter. FIG. 2 includes a high level block diagram of a host 100 connected to a data storage device 102. The data storage device 102 can include a buffer 104, a RAID engine 106, one or more non-volatile storage devices 108, and a memory controller 120.

The buffer 104 can include one or more bit cells where each bit cell can maintain a single bit of information. The bit cells of the buffer 104 can include a double data rate synchronous dynamic random-access memory (DDR SDRAM) bit cell. The buffer 104 can be partitioned into a plurality of logical blocks. The partition of the plurality of logical blocks can be determined by the memory controller 120. The buffer 104 can be configured to communicate with host 100 to send data to or receive data from host 100. The buffer 104 can operate as an interface of the data storage device to communicate with the host device.

The RAID engine 106 can process the host data to determine parity bits associated with the host data. For example, the RAID engine 106 can perform a bit-wise exclusive OR (XOR) operation on two or more of the plurality of logical blocks. The parity bits can be useful for detecting an error in stored data and for correcting the error in stored data, as further disclosed below.

The non-volatile storage devices 108 can include a memory device that can retain stored information even without power. In preferred embodiments, the non-volatile storage devices 108 can include a flash memory device. In other embodiments, the non-volatile storage devices 108 can include a read-only memory (ROM) or a ferroelectric random access memory (F-RAM). The memory controller 120 can include a circuit that can manage data flow of the non-volatile memory devices. The buffer 104, the RAID engine 106, the non-volatile storage devices 108, and the memory controller 120 can be implemented in hardware, e.g., as a circuitry on a semiconductor device.

The host device 100 can issue a write command 110 to the data storage device 102 to cause the data storage device 102 to store host data. The host data can be included in the write command 110; the host data can be sent to the data storage device 102 as a separate message. The data storage device 102 can temporarily store the host data at a buffer 104, where the host data is logically segmented into several data blocks each occupying a logical block of the buffer 104. The size of the logical block may be determined by the controller 120.

Subsequently, the buffer 104 can provide the host data 112 to the RAID engine 106, and the RAID engine 106 can compute the parity bits based on the host data 112. The RAID engine can then provide the parity bits 204 to the one or more non-volatile storage 108 directly (i.e., without going through any other computing units), instead of providing the parity bits to the buffer 104. This mechanism can provide at least two benefits compared to the typical RAID process. First, the data storage device 102 can reduce the data path of the parity bits, thereby reducing the latency associated with write operations. Second, the buffer 104 does not need to maintain an empty logical block to hold the parity bits. For example, if the buffer 104 includes eight logical blocks, the buffer 104 can utilize all eight logical blocks to store the host data, instead of utilizing less than all logical blocks (i.e., leaving one or more logical blocks empty) to store parity bits received from the RAID engine 106. This way, the data storage device 102 can increase the throughput of write operations.

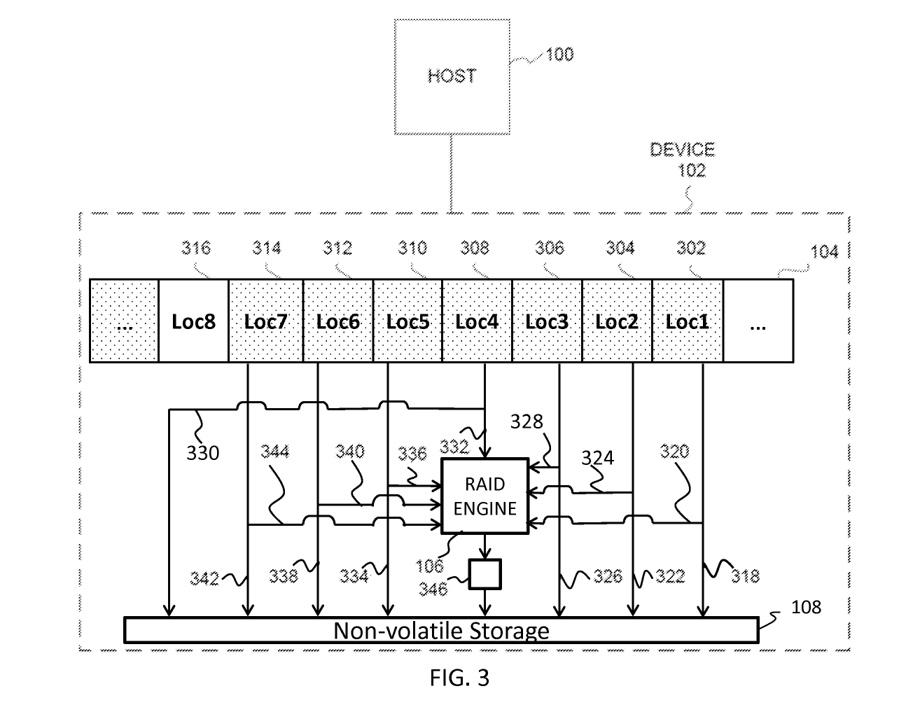

FIG. 3 illustrates a detailed process for writing data to a data storage device in accordance some embodiments of the disclosed subject matter. In this embodiment, the buffer 104 is partitioned into 8 logical blocks 302-316, each logical block configured to store one or more bits of data received from the host device 100. The buffer 104 can be partitioned by the memory controller 120.

When the host device 100 provides host data, the controller 120 can store the host data in one or more logical blocks in the buffer 104. The buffer 104 can subsequently provide the data blocks in logical blocks to the one or more non-volatile storage devices 108, as shown in paths 318, 322, 326, 330, 334, 338, and 342. Each path can carry a data block associated with the host data. The data blocks from the logical blocks can also be sent to the RAID engine 106 as shown in paths 320, 324, 328, 332, 336, 340, and 344. Each path can carry a data block associated with the host data.

Subsequently, the RAID engine 106 can perform a mathematical operation to create parity bits based on the received data blocks. In some cases, the mathematical operation can include a Boolean exclusive OR (XOR) operation. For example, the RAID engine 106 can perform, on a bit-by-bit basis, an XOR operation on at least two of the received data blocks:

Pᵢ=Aᵢ¹ [symbol] Aᵢ² [symbol] Aᵢ³ . . . [symbol] Aᵢ^{N}

where Pᵢ indicates the i^{th} bit of the parity bits; Aᵢ^{k} indicates the i^{th} bit of the k^{th} data block; and [symbol] indicates a bit-wise XOR operator. Once the RAID engine 106 creates the parity bits, the parity bits 346 can be provided to the non-volatile storage device 108, without being sent back to the buffer 104.

Because the parity bits 346 are not sent back to the buffer 104, the buffer 104 can utilize the additional logical block 316, traditionally set aside to hold the parity bits 346, for other processes, such as holding additional data, or for any tasks assigned to the buffer 104.

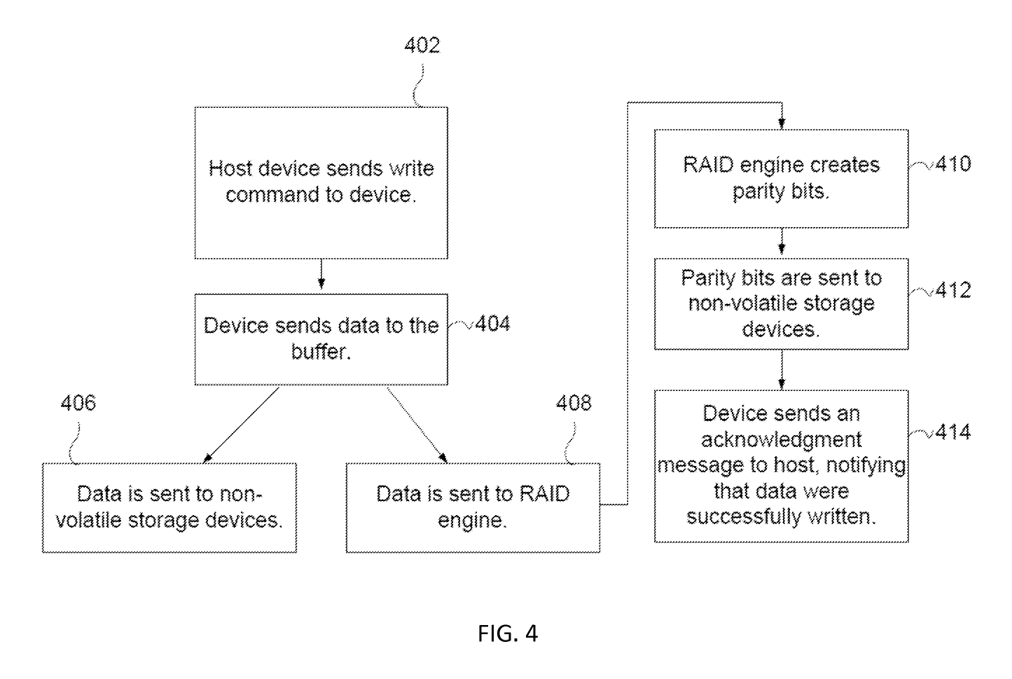

FIG. 4 illustrates a high level flow chart illustrating the process for writing host data in accordance with some embodiments of the disclosed subject matter. In step 402, the host device 100 can send a write command to the data storage device 102 to write host data. In some embodiments, the host data can be included in the write command. In other embodiments, the host data can be sent to the data storage device 102 as a separate message. In step 404, the memory controller 120 can send the received host data to the buffer 104 so that the buffer 104 can store the host data as data blocks in one or more logical blocks of the buffer 104.

Subsequently, in step 406, the buffer 104 can provide the data blocks to one or more non-volatile storage devices 108. Also, in step 408, the buffer 104 can provide the data blocks to the RAID engine 106. In some embodiments, the buffer 104 can provide the host data to the non-volatile storage devices 108 and the RAID engine 106 substantially simultaneously (i.e., in parallel). In other embodiments, the buffer 104 can provide the host data to the one or more non-volatile storage devices 108 and the RAID engine 106 sequentially. In some cases, the step 406 can be performed before the step 408; in other cases, the step 406 can be performed after the step 408.

In step 410, the RAID engine 106 can compute parity bits from the received data blocks. The RAID engine 106 can create the parity bits using a mathematical function, such as an XOR operation. In step 412, the RAID engine 106 can directly send the computed parity bits to the non-volatile storage devices 108, without sending them back to the buffer 104. In step 414, once the host data and the parity bits are written into the one or more non-volatile storage devices 108, the controller 120 of the data storage device 102 can send an acknowledgment message to the host device 100, notifying the host device 100 that the host data have been successfully written into the non-volatile memory device 108.

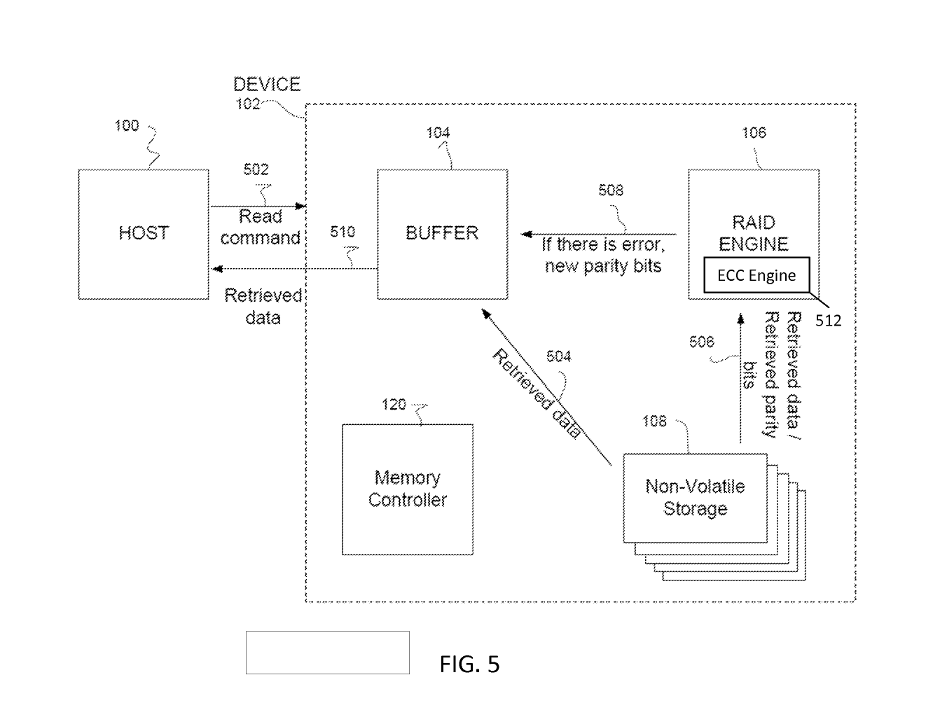

FIG. 5 illustrates a system and a process for reading data from a data storage device in accordance with some embodiments of the disclosed subject matter. FIG. 5 includes a high level block diagram of a host 100 connected to a data storage device 102. The data storage device 102 can include a buffer 104, a RAID engine 106, one or more non-volatile storage devices 108, a memory controller 120, and an error correcting code (ECC) engine 512. The ECC engine 512 can be configured to determine whether the stored data have been modified since they were last written into the non-volatile storage devices 108, either due to error or security breaches.

The disclosed systems and methods can reduce the latency associated with read operations by parallelizing the retrieval of stored data blocks and the error checking of stored data blocks. In particular, the non-volatile storage devices 108 are configured to provide the stored data blocks to both the buffer 104 and an ECC engine 512 substantially simultaneously, thereby reducing the latency associated with the ECC engine 512. In some cases, the ECC engine 512 can be a part of the RAID engine 106.

In step 502, the host device 100 can issue a read command 502 to the data storage device 102 to cause the data storage device 102 to retrieve and provide data. The read command 502 can specify the data to be retrieved using a data identifier. The data identifier can include an address that is indicative of the location of the non-volatile storage device 108 at which the data is stored. The address can be a physical address of the non-volatile storage device 108 at which the data is stored; the address can also be a logical address that can be translated into the physical address of the non-volatile storage device 108 at which the data is stored.

In step 504, the controller 120 can trigger the one or more non-volatile storage devices 108 to retrieve the data identified in the read command 502 and to provide the data to the buffer 104 so that the buffer 104 can temporarily maintain the retrieved data before being provided to the host device 100. The retrieved data can include a plurality of data blocks in accordance with the partition of the buffer 104.

In step 506, the controller 120 can also trigger the one or more non-volatile storage devices 108 to provide the retrieved data and their parity bits 506 to the ECC engine 512 and/or the RAID engine 106.

In some embodiments, the ECC engine 512 can determine whether the retrieved data and the retrieved parity bits are consistent (i.e., whether the retrieved data include a bit error.) For example, the ECC engine 512 can perform a mathematical operation on the retrieved data to determine whether parity bits associated with the retrieved data are identical to the parity bits retrieved from the non-volatile storage devices 108 (i.e., the parity bits computed during the write operation.) If they are consistent, the ECC engine 512 can provide a confirmation message to the memory controller 120, indicating that the retrieved data are correct and that the retrieved data can be provided to the host device 100. If they are not consistent, the ECC engine 512 can provide a flag to the memory controller 120 that there is a bit error in the retrieved data.

If there is a bit error in any one of the data blocks in the retrieved data, the ECC engine 512 can trigger the RAID engine 106 to compute new parity bits with which the original, uncorrupted data block can be recreated. If the retrieved data includes only one data block with a bit error, the RAID engine 106 can be configured so that the new parity bits are identical to the original, uncorrupted version of the data block. For example, the RAID engine 106 can compute the new parity bits based on the retrieved parity bits and portions of the retrieved data blocks that are free of error, which allows the RAID engine 106 to reconstruct the error-corrected data block.

In step 508, the RAID engine 106 can provide the new parity bits to the buffer 104. The buffer 104 can use the new parity bits to replace the corrupted data block in the buffer 104, thereby correcting the corrupted data block received directly from the non-volatile storage devices 108. In step 510, the buffer 104 can provide the retrieved data blocks to the host device 100, completing the data retrieve operation.

In some embodiments, the steps 504 and 506 can be performed sequentially. For example, the step 504 can be performed before step 506; or the step 506 can be performed before the step 504. In other embodiments, steps 504 and 506 can be performed in parallel (i.e., substantially simultaneously) since the two steps are independent. Performing steps 504 and 506 in parallel can reduce the latency of the read operation.

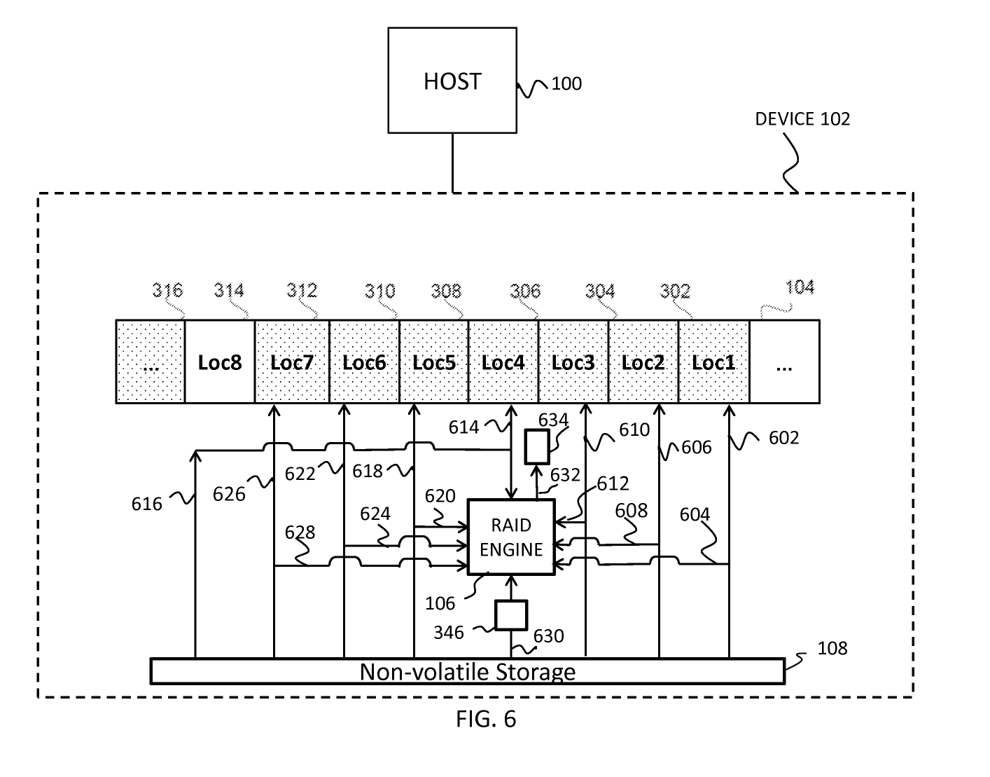

FIG. 6 illustrates a process for reading data from a data storage device in accordance some embodiments of the disclosed subject matter. As in FIG. 3, the buffer 104 includes 8 logical blocks 302-316, each logical block is configured to store one or more bits of data received from the one or more non-volatile storage devices 108.

Upon receiving a read request from the host device 100, the controller 120 can direct the non-volatile storage devices 108 to send requested data to the buffer 104. Subsequently, the non-volatile storage devices 108 can send the requested data to the buffer 104 via paths 602, 606, 610, 614, 618, 622, and 626. Each path can carry a data block associated with the requested data. The retrieved data blocks can be stored in the logical blocks, in this case, in logical blocks 302-314. Each path can carry a data block associated with the requested data.

In some embodiments, the retrieved data can be also be provided to an error correcting code (ECC) engine, which can determine whether there is any error in the retrieved data. If the ECC engine 512 determines that the retrieved data include one error (i.e., only one of the logical blocks in the buffer is corrupted), then the ECC engine 512 can cause the RAID engine 106 to provide new parity bits to the buffer 104 so that the buffer 104 can correct the detected error.

To this end, the RAID engine 106 can receive the requested data via paths 604, 608, 612, 616, 620, 624, and 628. Each path can carry a data block associated with the requested data. In some embodiments, the RAID engine 106 can receive the requested data in parallel with the buffer 104. The RAID engine 106 can use uncorrupted data blocks of the requested data and the corresponding parity bits 346, created during the write operation of the retrieved data, to compute the new parity bits. For example, suppose that the data block corresponding to the logical block 304 has an error. In this case, the RAID engine 106 can combine the parity bits 346 with the data blocks received via paths 604, 612, 616, 620, 624, and 628, excluding path 608 which is associated with the corrupted data block, to create new parity bits 634. The new parity bits 634 can be created using a mathematical function. In some cases, the mathematical function can include an XOR operation. For example, the RAID engine 106 can perform, on a bit-by-bit basis, an XOR operation on data in each logical block:

Bᵢ²=Aᵢ¹ [symbol] Aᵢ³ . . . [symbol] Aᵢ^{N} [symbol] Pᵢ

where Pᵢ indicates the i^{th} bit of the parity bits computed during the write operation; Aᵢ^{k} indicates the i^{th} bit of the k^{th} data block; [symbol] indicates the XOR operator; and Bᵢ² indicates the i^{th} bit of the new parity bits for the second data block. Once the RAID engine 106 creates the new parity bits 634, the RAID engine 106 can provide the new parity bits 634 to the buffer 104 at which the corrupted data at the logic block 304 can be corrected using the new parity bits 634. In some cases, if there is only one logical block with corrupted data, in this case the second block, then the new parity bits Bᵢ² can be identical to the original uncorrupted data. In some cases, the new parity bits 634 can be placed in any open (i.e., empty) logical block in the buffer 104. In some embodiments, the RAID engine 106 can include the ECC engine 512.

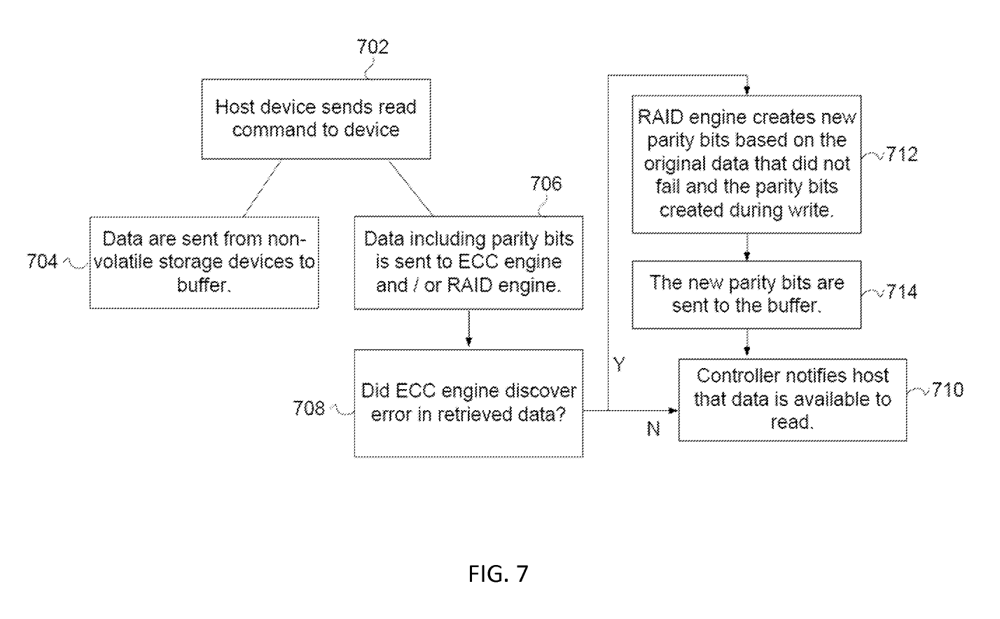

FIG. 7 illustrates a flow chart illustrating a read process in accordance with some embodiments of the disclosed subject matter. In step 702, the host device 100 can send a read command to the data storage device 102, requesting the device 102 to retrieve and provide data to the host device 100. In step 704 the controller 120 in the data storage device 102 can trigger the one or more non-volatile storage devices 108 to provide the requested data to the buffer 104. The requested data can include a plurality of data blocks, each corresponding to one of the logical blocks in the buffer 104. In step 706, the controller 120 can also trigger the one or more non-volatile storage devices 108 to provide (1) the requested data (i.e., the plurality of data blocks) and (2) the parity bits associated with the requested data to the ECC engine 512 and/or the RAID engine 106. In some cases, the ECC engine 512 can be a part of the RAID engine 106. In some embodiments, steps 704 and 706 can be performed in parallel (i.e., substantially simultaneously); in other embodiments, steps 704 and 706 can be performed sequentially.

In step 708, the ECC engine 512 can determine whether any one of the plurality of data blocks have been corrupted (i.e., has an error). The ECC engine 512 can do so by comparing the parity bits computed based on the plurality of retrieved data blocks and the retrieved parity bits (i.e., the parity bits that were computed during the write operation.) If the parity bits computed based on the plurality of retrieved data blocks are identical to the retrieved parity bits, then the retrieved data blocks do not have any error; if the parity bits computed based on the plurality of retrieved data blocks are not identical to the retrieved parity bits, then one or more of the retrieved data blocks have a bit error.

If the ECC engine 512 does not detect any bit error in the retrieved data blocks, the data storage device 102 can proceed to step 710. In step 710, the data storage device 102 can provide the retrieved data to the host device 100. In this step, in some embodiments, the controller 120 in the data storage device 102 can notify the host device 100 that the requested data is available to be read from the buffer 104. In other embodiments, the controller 120 can trigger the buffer 104 to provide or send the retrieved data to the host device 100.

If the ECC engine 512 does detect an error in the retrieved data, the data storage device 102 can proceed to step 712. If the number of errors determined by the ECC engine 512 is one, then the RAID engine 106 can correct the detected error. In step 712, the RAID engine 106 can compute new parity bits based on (1) uncorrupted data blocks of the requested data and (2) the retrieved parity bits 346, created during the write operation of the retrieved data. The RAID engine 106 can compute the new parity bits by performing a mathematical operation on (1) uncorrupted data blocks of the requested data and (2) the retrieved parity bits 346, created during the write operation of the retrieved data. The mathematical operation can include a bit-wise XOR operation. If the number of errors determined by the ECC engine 512 is one, the output of the bit-wise XOR operation (i.e., the new parity bits) would be identical to the uncorrupted version of the corrupted data block. In step 714, the RAID engine 106 can provide the new parity bits to the buffer 104, and the buffer 104 can replace the corrupted data block with the new parity bits. Subsequently, the data storage device can proceed to step 710.

Those of skill in the art would appreciate that the various illustrations in the specification and drawings described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (for example, arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

The terms “SSD”, “SSD device”, and “SSD device” as used herein are meant to apply to various configurations of solid state devices equipped with SSD controllers in accordance with one or more of the various embodiments of the disclosed subject matter. It will be understood that other types of non-volatile mass storage devices in addition to flash memory devices may also be utilized for mass storage.

We claim:

1. A solid state device comprising:
a buffer comprising a plurality of bit cells, configured to maintain a plurality of bits of information;
a memory controller configured to logically partition the plurality of bit cells into a plurality of logical blocks, each configured to maintain a data block comprising at least one bit of information; and
a Redundant Array of Independent Disks (RAID) engine coupled to the buffer;
wherein the buffer is configured to provide a plurality of data blocks from the plurality of logical blocks to the RAID engine, and in response, the RAID engine is configured to compute first parity bits from the plurality of data blocks and directly provide the first parity bits to one of a plurality of flash memory devices.

2. The solid state device of claim 1, wherein the buffer is further configured to provide the plurality of data blocks, stored in the plurality of logical blocks, to the plurality of flash memory devices.

3. The solid state device of claim 2, wherein the buffer is configured to provide the plurality of data blocks to the plurality of flash memory devices based on a RAID 5 scheme.

4. The solid state device of claim 2, wherein the buffer is configured provide the plurality of data blocks to the RAID engine and to the plurality of flash memory devices substantially simultaneously.

5. The solid state device of claim 1, wherein the RAID engine is configured to perform a bit-wise exclusive OR (XOR) operation on at least two of the plurality of data blocks.

6. The solid state device of claim 1, further comprising an error correcting code (ECC) engine, configured to receive the plurality of data blocks and the first parity bits from the plurality of flash memory devices and determine whether one of the plurality of data blocks comprises a bit-error.

7. The solid state device of claim 6, wherein the ECC engine is configured to compute temporary parity bits based on the plurality of data blocks and compare the temporary parity bits to the first parity bits received from the plurality of flash memory devices to determine whether one of the plurality of data blocks comprises a bit-error.

8. The solid state device of claim 6, wherein, when one of the plurality of data blocks comprises a bit-error, the RAID engine is configured to compute second parity bits based on portions of the plurality of data blocks without the bit-error and the first parity bits, and provide the second parity bits to the buffer.

9. The solid state device of claim 8, wherein the ECC engine is a part of the RAID engine.

10. The solid state device of claim 6, wherein the plurality of flash memory devices is configured to provide the plurality of data blocks to the buffer and the ECC engine substantially simultaneously.

11. A method of operating a solid-state device, the method comprising:
partitioning, by a memory controller, a plurality of bit cells in a buffer into a plurality of logical blocks, each of which is configured to maintain a data block comprising at least one bit of information;
receiving data, by the buffer, from a host device, and maintaining the data in the plurality of logical blocks as a plurality of data blocks;
providing, by the buffer, the plurality of data blocks to a RAID engine;
computing, by the RAID engine, first parity bits from the plurality of data blocks; and
providing, by the RAID engine, the first parity bits directly to one of a plurality of flash memory devices.

12. The method of claim 11, further comprising providing, by the buffer, the plurality of data blocks, stored in the plurality of logical blocks, to the plurality of flash memory devices.

13. The method of claim 12, wherein providing the plurality of data blocks to the plurality of flash memory devices comprises providing provide the plurality of data blocks to the plurality of flash memory devices based on a RAID 5 scheme.

14. The method of claim 12, wherein providing the plurality of data blocks to the RAID engine and providing the plurality of data blocks to the plurality of flash memory devices occur substantially simultaneously.

15. The method of claim 11, wherein computing the first parity bits from the plurality of data blocks comprises performing a bit-wise exclusive OR (XOR) operation on at least two of the plurality of data blocks.

16. The method of claim 11, further comprising:
receiving, by an error correcting code (ECC) engine, the plurality of data blocks and the first parity bits from the plurality of flash memory devices; and
determining, by the ECC engine, whether one of the plurality of data blocks comprises a bit-error.

17. The method of claim 16, further comprising:
computing, by the ECC engine, temporary parity bits based on the plurality of data blocks; and
comparing, by the ECC engine, the temporary parity bits to the first parity bits received from the plurality of flash memory devices, thereby determining whether one of the plurality of data blocks comprises a bit-error.

18. The method of claim 16, further comprising:
when one of the plurality of data blocks comprises a bit-error,
computing, by the RAID engine, second parity bits based on portions of the plurality of data blocks without the bit-error and the first parity bits; and
providing, by the RAID engine, the second parity bits to the buffer.

19. The method of claim 16, wherein the RAID engine includes the ECC engine.

20. The method of claim 16, further comprising providing, by the plurality of flash memory devices, the plurality of data blocks to the buffer and the ECC engine substantially simultaneously.
